(19) United States
(12) Patent Application Publication
(10) Pub. No.: US 2002/0063760 A1
(43) Pub. Date: May 30, 2002

(54) Remotely-powered ink cartridge identification system for an inkjet printer

(76) Inventors: Steven J. Dietl, Ontario, NY (US); Frederick A. Donahue, Walworth, NY (US)

Correspondence Address: LAWRENCE HARBIN, ONE MASSACHUSETTS AVENUE, N.W., SUITE 330, WASHINGTON, DC, 20001, US

(21) Appl. No.: 09/725,226

(22) Filed: Nov. 29, 2000

(51) Int. Cl. B41J 29/393

(52) U.S. Cl. 347/86

(57) ABSTRACT

A system is provided for identifying an ink cartridge. The system includes an a printer having a main body. An ink cartridge is provided which includes radio frequency identification structure having an integrated circuit and antenna structure. A sensing structure is attached to the main body of the printer. The sensing structure is constructed and arranged to transmit a powering signal. The radio frequency identification structure is constructed and arranged to (1) receive the powering signal and to convert the powering signal to a voltage to power the integrated circuit and (2) transmit a radio frequency digital signal which identifies at least one characteristic of the ink cartridge for receipt by the sensing structure.

### FIELD OF THE INVENTION

This invention relates to ink jet printers and, more particularly, to an ink cartridge and identification system which confirms that a proper replacement ink cartridge, designed to be used for a particular printer or having a proper ink color, has been installed in the printer.

### BACKGROUND OF THE INVENTION

Ink jet printers eject ink onto a print medium such as paper in a controlled pattern. Typically, such printers have a low ink level warning light to alter a user to replace the ink cartridge so that ink does not run out during a print job. In replacing the ink cartridge, if an incorrect size or brand cartridge is forced into a printer, damage to both the cartridge and printer may occur. Furthermore, if the wrong cartridge is installed, printing quality may suffer.

Conventionally, optical sensing systems are used to determine if the proper brand or size cartridge is installed in a printer. However, such systems are difficult to make robust in the presence of the cartridge, printer, and sensor tolerances. This inherent lack of robustness is primarily due to the necessity to resolve varying levels of reflected light to sense, in an analog fashion, the cartridge brand. The optical sensing system also adds to the ink cartridge cost and makes the cartridge prone to ink leakage.

A digital sensing method is considered to be advantageous in the area of tolerance robustness but such systems typically require electrical connections to energize components. However, conventional ink cartridge designs have no provisions for electrical connections.

Accordingly, there is a need to provide a remotely-powered digital cartridge identification system to ensure that the proper brand and/or color ink cartridge is installed into the printer.

### SUMMARY OF THE INVENTION

An object of the present invention is to fulfill the need referred to above. In accordance with the principles of the present invention, this objective is obtained by providing a system for identifying an ink cartridge. The system includes a printer having a main body. An ink cartridge is provided which includes radio frequency identification structure having an integrated circuit and antenna structure. A sensing structure is attached to the main body of the printer. The sensing structure is constructed and arranged to transmit a powering signal. The radio frequency identification structure is constructed and arranged to (1) receive the powering signal and to convert the powering signal to a voltage to power the integrated circuit, and (2) transmit a radio frequency digital signal, which identifies at least one characteristic of the ink cartridge, for receipt by the sensing structure.

In accordance with another aspect of the invention, an ink cartridge includes a main body for containing ink. A radio frequency identification structure is attached to the main body. The radio frequency identification structure has an integrated circuit and antenna structure and is constructed and arranged to (1) receive a powering signal and to convert the powering signal to a voltage to power the integrated circuit, and (2) transmit a radio frequency digital signal which identifies at least one characteristic of the ink cartridge.

In accordance with yet another aspect of the invention a method of identifying an ink cartridge in a printer provides an ink cartridge including radio frequency identification structure. The radio frequency identification structure has an integrated circuit and antenna structure. A sensing structure is attached to the printer. A powering signal is transmitted from the sensing structure and is received by the radio frequency identification structure. The powering signal is converted to a voltage to power the integrated circuit. The radio frequency identification structure transmits a radio frequency digital signal which identifies at least one characteristic of the ink cartridge which is received by the sensing structure.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

Reference is made to the attached drawings, wherein elements having the same reference numeral designations represent like elements throughout and wherein:

FIG. 1 is a schematic illustration of an ink jet printer including a remotely-powered digital cartridge identification system provided in accordance with a first embodiment of the present invention.

FIG. 2 is a schematic view of a radio frequency identification structure of the system of FIG. 1.

FIG. 3 is a schematic illustration of an ink jet printer including a remotely-powered digital cartridge identification system provided in accordance with a second embodiment of the present invention.

FIG. 4 is a schematic view of a radio frequency identification structure of the system of FIG. 3.

### DETAILED DESCRIPTION OF THE INVENTION

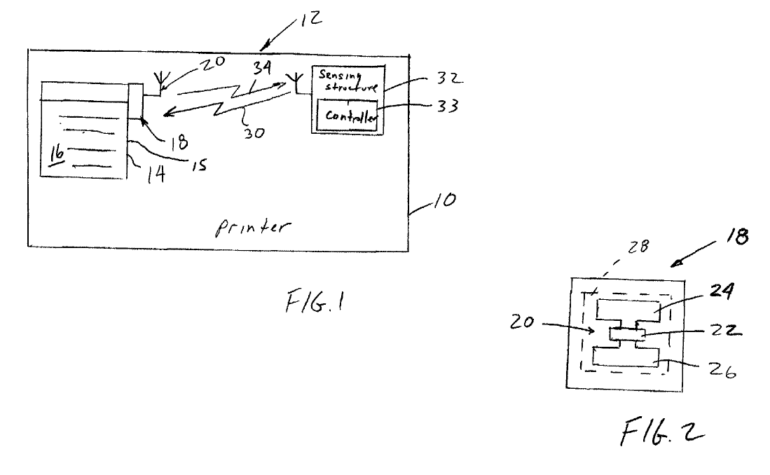

Referring to FIG. 1, a schematic illustration of an ink jet printer, generally indicated at 10, is shown provided in accordance with a first embodiment of the present invention. The printer 10 includes a remotely powered digital cartridge identification system, generally indicated at 12. The system 12 includes an ink cartridge 14 for containing ink 16 for printing. The ink cartridge 14 includes a radio frequency identification structure 18. The identification structure 18 can be molded into the cartridge 14 or otherwise attached as a tag or label to surface of the main body 15 of the cartridge 14.

As best shown in FIG. 2, the identification structure 18 comprises antenna structure 20 and an integrated circuit (IC) 22 of the type, for example, disclosed in U.S. Pat. No. 6,130,613, the contents of which is hereby incorporated into to the present specification by reference. In the preferred arrangement shown in FIG. 2, the identification structure 18 is a capacitive coupled device. Antenna structure 20, generally indicated at 20 includes a transmit antenna 24 and a receive antenna 26. IC 22 includes a first conductive pad and a second conductive pad (not shown) for coupling via adhesive layer 28 respectively to the transmit antenna 24 and the receive antenna 26. It will be appreciated that identification structure 18 may be arranged as an inductive-coupled device with a coil antenna and a suitable inductive coupled IC.

Depending on the application, the identification structure 18 may be arranged for read only operation or for read/write operation. For example, in an ink cartridge identification application, a read only IC may be used and contain stored information indicative of the type, brand, color, or other characteristics of the ink cartridge 14. The stored information can be achieved by making a special wafer configuration for each brand and or ink color, or by using fusable links to “burn-in” a unique signal for a particular brand and/or color.

A powering signal 30 in the form of a directional radio frequency signal transmitted from a sensing structure 32 (FIG. 1), is received by the identification structure 18 and is converted to a voltage. The voltage powers-up the IC 22 and thereafter, the IC 22 generates a read signal 34 in the form of a radio frequency digital signal containing some or all of the stored information which identifies one or more characteristics of the ink cartridge 14. The read signal 34 containing the stored information is transmitted to the sensing structure 32. The sensing structure 32 is mounted to a fixed portion of the body of the printer 10. The sensing structure 32 includes antenna structure 36 for transmitting and receiving radio frequency signals and a controller 33 to which the read signal 34 is communicated. The controller 33 can be provided separate from the sensing structure 32. Upon receiving the read signal 34 the controller 33 compares the read signal 34 to a default to determine if the proper color, brand, etc. of ink cartridge 14 is installed in the printer 10.

It is also contemplated that identification structure 18 operate in a read/write manner. In a read/write embodiment of the present invention, IC 22 may contain preprogrammed stored information, such ink cartridge color and/or brand, and/or have information communicated to it and retained as stored information.

Once the proper ink cartridge 14 is confirmed and is used in the printer 10, the level of ink remaining in the ink cartridge 14 can be sensed by pixel counting or grouping as described, for example, in U.S. Pat. No. 5,867,198, the contents of which is hereby incorporated into the present specification by reference.

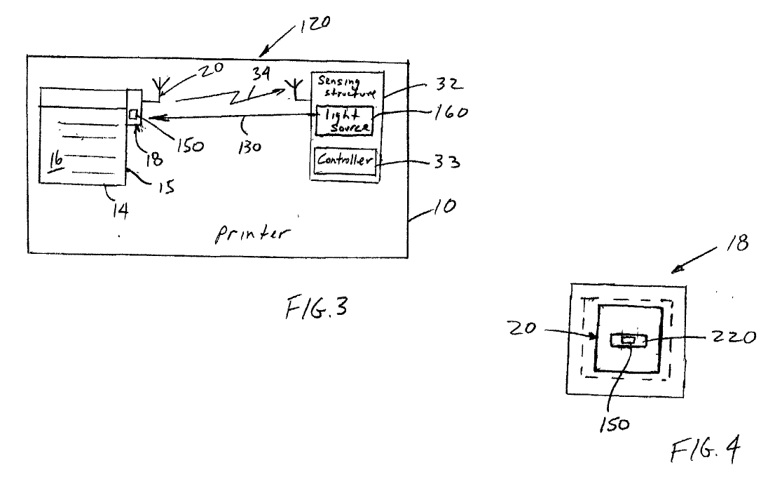

A second embodiment of the identification system 120 is shown in FIG. 3. The system 120 is similar to that of FIG. 1, but instead of using radio frequency signal to power the IC, the IC 220 (FIG. 4) of the identification structure 18 includes a photovoltaic cell 150 which receives a powering signal 130 in the form of an infrared light beam from a light source 160 to power the IC 220. Upon powering of the IC, the identification structure 18 transmits the read signal 34 via antenna 20 to the sensing structure 32.

Thus, the remotely-powered identification system of the invention provides a means of ensuring that an ink cartridge with a confirmed characteristic is installed in a printer without the need to provide electrical connections on the ink cartridge.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An system for identifying an ink cartridge comprising:
a printer having a main body,
an ink cartridge including radio frequency identification structure, the radio frequency identification structure having an integrated circuit and antenna structure, and
a sensing structure attached to the main body of the printer, the sensing structure being constructed and arranged to transmit a powering signal,
the radio frequency identification structure being constructed and arranged to (1) receive the powering signal and to convert the powering signal to a voltage to power the integrated circuit, and (2) transmit a radio frequency digital signal, which identifies at least one characteristic of the ink cartridge, for receipt by the sensing structure.

2. The system of claim 1, wherein the powering signal is a radio frequency signal received by the antenna structure of the ink cartridge.

3. The system of claim 1, wherein the radio frequency identification structure includes a photovoltaic cell and the powering signal is an infrared light signal received by the photovoltaic cell.

4. The system of claim 2, wherein the antenna structure includes a receive antenna and a transmit antenna.

5. The system of claim 3, wherein the antenna structure includes a transmit antenna.

6. The system of claim 1, wherein the radio frequency digital signal identifies the color of ink in the ink cartridge.

7. The system of claim 1, wherein the radio frequency digital signal identifies a brand of the ink cartridge.

8. An ink cartridge comprising:
a main body for containing ink, and
a radio frequency identification structure attached to the main body, the radio frequency identification structure having an integrated circuit and antenna structure, the radio frequency identification structure being constructed and arranged to (1) receive a powering signal and to convert the powering signal to a voltage to power the integrated circuit, and (2) transmit a radio frequency digital signal which identifies at least one characteristic of the ink cartridge.

9. The ink cartridge of claim 8, wherein the powering signal is a radio frequency signal received by the antenna structure.

10. The ink cartridge of claim 8, wherein the radio frequency identification structure includes a photovoltaic cell and the powering signal is an infrared light signal received by the photovoltaic cell.

11. The ink cartridge of claim 9, wherein the antenna structure includes a receive antenna and a transmit antenna.

12. The ink cartridge of claim 10, wherein the antenna structure includes a transmit antenna.

13. The ink cartridge of claim 8, wherein the radio frequency digital signal identifies the color of ink in the ink cartridge.

14. The ink cartridge of claim 8, wherein the radio frequency digital signal identifies a brand of the ink cartridge.

15. A method of identifying an ink cartridge in a printer including:
providing the ink cartridge including radio frequency identification structure, the radio frequency identification structure having an integrated circuit and antenna structure,
providing a sensing structure attached to the printer,
transmitting a powering signal from the sensing structure,
receiving the powering signal by the radio frequency identification structure,
converting the powering signal to a voltage to power the integrated circuit,
transmitting, from the radio frequency identification structure, a radio frequency digital signal which identifies at least one characteristic of the ink cartridge, and
receiving the radio frequency digital signal by the sensing structure.

16. The method of claim 15, wherein the step of transmitting a powering signal includes transmitting a radio frequency signal.

17. The method of claim 15, wherein the radio frequency identification structure includes a photovoltaic cell and the step of transmitting a powering signal includes transmitting an infrared light signal and the step of receiving the powering signal includes receiving the powering signal by the photovoltaic cell.

18. The method of claim 15, further including comparing at the sensing structure the radio frequency digital signal to a default.
